(19) United States
(12) Patent Application Publication
(10) Pub. No.: US 2011/0089616 A1
(43) Pub. Date: Apr. 21, 2011

(54) METHOD FOR PURDUCING A MOLDED WOOD MATERIAL PART

(75) Inventor: Kurt Nonninger, Ense (DE)

(73) Assignee: PFEIDERER AG, NEUMARKT (DE)

(21) Appl. No.: 12/995,883

(22) PCT Filed: Jun. 2, 2009
(86) PCT No.: PCT/EP09/03919

§ 371 Date: Dec. 2, 2010

(30) Foreign Application Priority Data
Jun. 2, 2008 (DE) 10 2008 026 258.7

(51) Int. Cl. B27N 3/08; B27N 3/18

(52) U.S. Cl. 264/552; 425/363

(57) ABSTRACT

A method for producing a molded wood material part with the use of a basic wood material and a heat-curable binding agent by way of pressing. In order to cure the binding agent, heat is transferred into the molded wood material part in the form of a steam shock. In order to shorten the pressing time, the process air pressure prevailing in the pressing chamber is increased before the transfer of heat in the form of a steam shock in relation to the atmospheric air pressure prevailing outside the pressing chamber, but without also supplying moisture, in particular in the form of water vapor, to the molded wood material part.

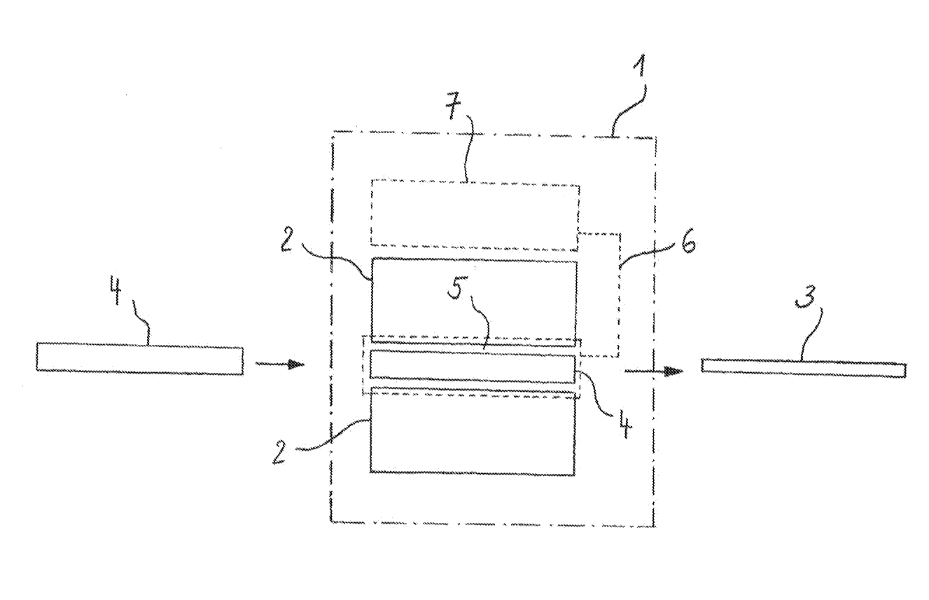

The invention relates to a method for producing a wood-base material using a wood-base material molding and a thermally curable binder by pressing, the binder being cured by transferring heat into the wood-base material molding in the form of a steam pulse.

Such methods are known from the prior art. The duration of the pressing time is influenced primarily by how quickly the binder cures. Using the example of a wood-base material panel of three-layer structure, which consists of a middle layer, an upper outer layer and a lower outer layer, the approaches to a solution are known from the prior art are described hereinafter.

To produce the panel, a wood-base material mat (web) of three-layer structure, consisting of the wood-base material and a thermally curable binder, is fed to a press. This is followed by a hot pressing operation. The binder (glue) in the outer layers is cured by directly supplying heat via heatable pressing plates or belts. Owing to the thermal energy introduced into the panel on the one hand and the moisture present in the panel the other hand, a water vapor pressure gradient develops in the panel.

The thermal energy required to cure the middle layer is introduced into the panel via what is called the steam pulse. For this purpose, the outer pressing plates are heated, for example, to 200 Celsius. In the course of compression, the (glue water) in outer layers then heats up and, on attainment of the boiling temperature (100° C.), is converted abruptly to the vapor phase. Owing to the water vapor gradient, this vapor shoots vertically from both sides of the panel in the direction of the middle of panel. This operation is referred to a steam pulse.

Owing to the temperature gradient between the outsides of the outer layers and the middle of the middle layer (the temperature difference is, for example, 75° C.), the steam condenses in the still cool middle layer. This releases heat of condensation, which increases the temperature in the middle layer. The chemical curing reactions in the middle layer proceed more rapidly, and less time passes before the binder has cured, the result of which is that the pressing time required is shortened. This steam pulse principle is used in the production of numerous wood-base material moldings, for example the production of particleboard, MDF, OSB, etc.

It is known from the prior art that the steam pulse principle can be optimized by heating the water vapor beforehand and blowing it the wood-base material molding under pressure in the form of steam. This is also referred to as the steam injection technique. As a result of this, shortening of the pressing time is also possible to a limited degree.

However, a disadvantage in the steam injection technique is that more water also gets into the interior of the wood-base material molding. Owing to the basic principle of pressure and opposing pressure, the internal pressure in the wood-base material molding is greatly increased in the case of the injection technique. When the press is opened, the binder in the interior of the molding must already have cured to such an extent that the internal vapor pressure does not lead to damage (parts flaking off) or destruction of the molding (delamination). Attempts are made to counteract this disadvantage with complex cooling devices to cool the moldings after hot pressing. Nevertheless, the press has to remain closed for a comparatively long time in the case of the steam injection technique, such that the time advantage of rapid curing of the binder is partly eliminated.

It is an object of the present invention to provide a technique for production of a wood-base material molding, with the aid of which the pressing time can be shortened without the above-described disadvantages of the prior art.

This object is achieved by a method according to claim 1 or by a press according to claim 4. Advantageous embodiments of the invention are specified in the dependent claims.

The characterizing feature of the method according to the invention is that the heat transfer in the form of a steam pulse is preceded by an increase in the operating air pressure within the pressing chamber compared to the atmospheric air pressure outside the pressing chamber, but without supplying additional moisture, especially in the form of water vapor, to the wood-base material molding

A press provided for the production of such a wood-base material molding is characterized by a pressing chamber and a device for generating an elevated pressure such that the heat transfer in the form of a steam pulse is preceded by an increase in the operating air pressure within the pressing chamber compared to the atmospheric air pressure outside the pressing chamber, but without supplying additional moisture, especially in the form of water vapor, to the wood-base material molding.

A first basic idea of the invention is no longer to pursue the steam injection technique in which hot steam is injected into the molding under pressure, which is leading into a technological cul-de-sac. Instead, there is a return to the original steam pulse technique, in which the steam pulse is automatic on attainment of the boiling temperature. The steam pulse technique is improved in accordance with the invention by virtue of the air pressure being greater at least in the pressing chamber of the press than the atmospheric pressure of the environment during the pressing operation. In other words, the pressing operation takes place under elevated pressure, for example at 1.5 bar. At such an elevated pressure, the water evaporates at higher temperatures, for example at 110° C. The steam pulse is still automatic, but this time at a higher temperature. Compared to a method which proceeds under atmospheric pressure, the steam pulse under some circumstances occurs at a somewhat later time, but with a significantly higher energy content corresponding to the higher boiling temperature.

The invention makes use of the dependence of boiling temperature and boiling pressure on one another. By virtue of a pressure increase of, for example, 0.5 bar=500 hPa, an increase in the boiling temperature of water from 100° C. to about 110° C. is achieved. This increases the energy content of the steam compared to a method proceeding at atmospheric pressure. In the case of use of the same amount of water, with the aid of the steam pulse, more heat can be transferred into the interior of the wood-base material. This increases the temperature attainable in the middle layer. According to the van't Hoff rule (reaction rate-temperature rule), according to which the reaction rate approximately doubles when the temperature is increased by 10° C., the result of this is a significant increase in reaction rate for the chemical curing reactions of the binder. As a result, the pressing time can be shortened significantly, with the risk of delamination no longer being present since no additional water vapor is introduced into the molding.

In contrast to the above-described prior art, in which the thermal energy introduced into the wood-base material molding is increased essentially by increasing the amount of water vapor used, the present invention is based on the consideration of increasing the reaction rate of the curing reactions of the binder by transferring more thermal energy with an equal amount of water vapor. This allows a high operating temperature to be achieved without the disadvantages of an elevated internal pressure.

The water vapor formed comprises those moisture components of air which—provided that dry air is not used as the operating atmosphere—are in any case already present in the air, and also the water vapor which originates in the glue water of the outer layers. Thus, if “normal” air is used as the operating atmosphere, the partial pressure conditions in the pressing chamber or in the pressure chamber at the time of the steam pulse correspond essentially to the partial pressure conditions outside the pressing chamber or the pressure chamber.

The description which follows is intended to once again illustrate the difference between the known steam injection and the present invention:

In the conventional steam injection technique, the partial pressure conditions arise from a combination of (moist) air on the one hand and superheated steam additionally introduced into the system on the other hand:

Pₜₒₜₐₗ=p(air)+p(H₂O)

On attainment of the boiling temperature of 100° C., the steam pulse arises from the water vapor present in the moist air and from the water vapor which originates in the glue water 15 of the outer layers, and also from the superheated steam introduced in addition.

In the present invention, the introduction of superheated steam is dispensed with. In the pressure chamber there is only the customary operating atmosphere, generally air in the usual composition (78% nitrogen, 21% oxygen, . . . ). It follows that:

Pₜₒₜₐₗ=p(air)

The steam pulse which arises on attainment of the (elevated) boiling temperature of, example, 110° C. contains much less moisture and at the same time a higher thermal energy, which leads to the advantages explained above.

Since the pressing operation proceeds under elevated pressure, a pressure chamber is provided, with the desired elevated pressure therein. In that case, the atmospheric air pressure is understood to mean the air pressure in the atmosphere outside the pressure chamber, which is caused by the weight of the air. Operating air pressure, in contrast, is understood to mean the air pressure of that environment within which the pressing operation takes place. Since the pressing operation always takes place in a pressing chamber, for example in the press nip arranged between pressing plates or belts, the operating air pressure, in other words, is the air pressure (at least) within the pressing chamber, to which the wood-base material molding to be produced is exposed. In one embodiment of the invention, the pressing chamber, especially in form of the press nip, is configured as an essentially closed pressure chamber to attain the desired elevated pressure. In another embodiment of-the invention, a pressure chamber which, as well as the actual pressing chamber, encloses further parts of the is provided. In a further embodiment of the invention, the press has a pressure chamber which completely surrounds it; the entire press is then within the pressure chamber.

The press has technical equipment suitable for this purpose, which is familiar to those skilled in the art and therefore need not be detailed specifically at this point. When, for example, the press nip is configured as a pressure chamber, devices are provided for sealing the press nip, for example lateral sealing rings, pressure application devices, etc. In discontinuous presses, for example discontinuous single-or multistage presses, it is possible to provide lateral sealing surfaces which seal all four sides when the press is closed. In addition to the construction elements and seals for delimitation of the pressure chamber, a device for generating an elevated pressure should be provided. This may be an elevated pressure vessel which provides an elevated pressure of, for example 0.5 to 1.0 bar. An elevated pressure can be fed therefrom into the pressure chamber via pressure lines. Thus, the boiling point of water can be adjusted to, for example 100° C. to 150° C.

The method according to the invention is usable in the production of numerous wood-base material moldings, for example in the production of particleboard, MDF, HDF, OS, etc. These wood-base material moldings may be individual parts or a continuous part which runs continuously through the press. The method can be used either on discontinuous or continuous presses, for example on single- or multistage presses, double-belt presses, etc.

According to what kind of wood-base material moldings are to be produced, the wood-base material comprises turnings, fibers, strands. The thermally curable binders used may, for example, be urea resins, melamine resins or phenol resins, or mixtures thereof, or mixtures of these resins with polymeric diisocyanates (PMDI) or with natural binders, such as tannin resins and/or lignin resins.

A working example of the invention is explained in detail hereinafter with reference to the drawings. The sole FIGURE here shows a schematic diagram of the present invention with a discontinuous one-stage press 1 with pressing plates 2 for production of a particleboard 3.

In the case of particleboard 3, in a first method step, wood, wood residues, wood moldings, etc. are first converted to chips, i.e. suitable chipping methods employing disk-type chippers, long timber chippers, etc. are used to produce the desired optimal chip form. In a second method stem, the chips thus obtained are dried until final moisture contents in the range of 0.5-2% are attained. Subsequently, the chips are fractionated, i.e. divided into screen fractions. This is followed by separate gluing of the “outer and middle layer chips” with thermally curable resins, principally urea resins, melamine resins or phenol resins, or mixtures thereof or with polymeric diisocyanates (PMDI), or else with natural binders such as tannin resins and/or lignin resins. The fourth method step which follows after chipping, drying and gluing is the scattering of the glued chips by means of wind scattering or mechanical scattering, by means of which a “mat” 4 or “web” of chips is obtained. Viewed over the mat height, principally the smaller and finer outer layer chips are arranged at the top and bottom, while the coarser middle layer chips are present principally in the middle of the mat 4.

In this arrangement, the glued mat 4 is then fed to the press 1 in which simultaneous action of heat and pressure compresses the mat 4 down to the ultimate desired particleboard thickness while simultaneously curing the heat-curable binder.

The chemical reactivities of the binders used in the outer and middle layers (UF, MF, PF, MUF, PMDI, etc.) must be matched to the requirements of the compression reactions. Conversely, the moisture budget of the particleboard just formed must be exactly such that an optimal curing reaction can proceed in the outer and middle layers, and the particleboard 3 does not delaminate, i.e. shatter, as a result of excessive internal vapor pressure at the moment when it leaves the press 1 and the external pressure thus ceases. The duration of the pressing time is influenced primarily by how rapidly the binder cures. This is where the invention starts from.

The mat 4 is supplied to the press 1, the press nip 5 of which is configured as a pressure chamber. The press nip 5 is connected via pressure lines 6 to a pressure vessel 7, with the aid of which an elevated pressure of 1.5 bar is generated in the press nip 5 after the introduction of the mat 4 and the closure of the press nip 5 by means of suitable seals (not shown). Moisture, more particularly in the form of water vapor, is not supplied to the press nip 5 or the mat 4. By virtue of the increase in the operating air pressure, there is increase in the boiling temperature within the press nip 5. The steam which forms at 110° C. carries a significantly higher energy content, with the consequence that significantly more heat of condensation correspondingly also arrives with the steam pulse in the middle layer of the mat 4. The effect of this is that the curing reactions of the binder in the middle layer proceed significantly more rapidly. Thus, sufficient strength is attained significantly more rapidly in the middle layer. This allows the pressing time to be shortened considerably, or the advance rate of the press 1 to be increased significantly, without any risk that the particleboard 3 will delaminate when discharged from the press 1.

All features described in the description, the FIGURE and the claims which follow may be essential to the invention either individually or in any desired combination with one another.

### LIST OF REFERENCE NUMERALS

1 press

2 press plate

3 particleboard

4 mat

5 press nip

6 pressure line

7 pressure vessel

1-5. (canceled)

6. A method for producing a wood-base material molding, the method which comprises:
pressing a wood-base material and a thermally curable binder in a pressing chamber to form a wood-base material molding;
increasing an operating air pressure within the pressing chamber compared to an atmospheric air pressure outside the pressing chamber, substantially without supplying additional moisture to the wood-base material molding; and
subsequently curing the binder by a heat transfer into the wood-base material molding in the form of a steam pulse.

7. The method according to claim 6, which comprises preventing a supply of additional moisture in the form of water vapor.

8. The method according to claim 6, which comprises setting partial pressures in the pressing chamber, until the steam pulse is injected, to correspond substantially to partial pressure conditions outside the pressing chamber.

9. The method according to claim 6, which comprises setting the operating air pressure within the pressing chamber to at least 0.5 bar above the ambient air pressure.

10. A press assembly for producing a wood-base material molding from a wood-base material and a thermally curable binder, the press assembly comprising:
a press with a pressing chamber wherein the binder is cured by transferring heat into the wood-base material molding in form of a steam pulse;
a device for generating an elevated pressure such that the heat transfer in the form of the steam pulse is preceded by an increase in the operating air pressure within said pressing chamber compared to the atmospheric air pressure outside said pressing chamber, but without supplying additional moisture to the wood-base material molding.

11. The press according to claim 10, wherein said device is configured to avoid supplying additional moisture in the form of water vapor.

12. The press according to claim 9, wherein said pressing chamber is a substantially closed pressure chamber.

13. The press according to claim 9, wherein said pressing chamber is a press nip.
